(19) United States
(12) Patent Application Publication
(10) Pub. No.: US 2020/0209406 A1
(43) Pub. Date: Jul. 2, 2020

(54) Error Correction in GPS Signal

(71) Applicant: Alibaba Group Holding Limited, Grand Cayman (KY)

(72) Inventors: Ming Lin, Bothell, WA (US); Xiaomin Song, Issaquah, WA (US); Qi Qian, Issaquah, WA (US); Liang Sun, Bellevue, WA (US); Shenghuo ZHU, Bellevue, WA (US); Rong JIN, Sammamish, WA (US)

(21) Appl. No.: 16/235,487

(22) Filed: Dec. 28, 2018

(51) Int. Cl. G01S 19/40

(52) U.S. Cl. CPC G01S 19/40

(57) ABSTRACT

Methods and systems for correcting an error of a GPS signal are provided. The method includes receiving a request for positioning service from a computing device at a location; estimating a Total Electron Content (vTEC) value associated with the location of the object based at least in part on a plurality of vTEC values of a plurality of ground stations equipped with a plurality of GPS receivers, the vTEC value being estimated based on an estimator that is trained using a filter-reweight-retrain robust algorithm; and sending information of the estimated vTEC value to the computing device to allow the computing device to correct an error of a GPS signal received by the computing device, the error of the GPS signal being associated with an ionospheric delay.

### BACKGROUND

Global Positioning Systems (GPS) are widely used in the daily lives of people nowadays. A number of devices such as smartphones, computer-assisted navigation systems, etc., are installed with GPS receivers to enable the devices to determine corresponding current locations at real time. For common daily uses such as positioning of a person who is hiking or positioning of a fixed object which is not time sensitive or critical, a rough positioning, i.e., an error of positioning of an order of one meter or more, may be acceptable and tolerable. However, with the advent and development of automatic navigation system (e.g., automatic pilot systems), the requirements for the accuracy of positioning of a GPS system have been sharply increased. Errors associated with positioning of a GPS system can be temporal, positional, and/or weather dependent. In order to reduce these errors involved in the positioning of the GPS system, mechanisms are performed to calibrate or address these errors from a GPS signal to obtain a corrected GPS signal prior to determining a position of an object at issue.

### SUMMARY

This summary introduces simplified concepts of error correction of a GPS signal, which will be further described below in the Detailed Description. This summary is not intended to identify essential features of the claimed subject matter, nor is it intended for use in limiting the scope of the claimed subject matter.

This application describes example implementations of error correction of a GPS signal. A request for positioning service is received from a device having a GPS receiver at a location. A Total Electron Content (vTEC) value associated with the location of the device is estimated based at least in part on a plurality of vTEC values of a plurality of ground stations equipped with a plurality of GPS receivers and an estimator that is trained using a filter-reweight-retrain robust algorithm. After estimating the vTEC value, information of the estimated vTEC value is sent to the device to allow the device to correct an error of a GPS signal received by the device. In implementations, the error of the GPS signal may be associated with an ionospheric delay.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates major sources of errors along a path of microwave transmission in a high precision positioning system.

FIG. 2 illustrates an example environment in which a GPS correction system may be used.

FIG. 3 illustrates the example GPS correction system in more detail.

FIG. 4 illustrates an example method of training an estimator for estimating a vTEC value at a location.

FIG. 5 illustrates an example method of providing information of a vTEC value for correcting a GPS signal.

FIG. 6 illustrates an example method of correcting a GPS signal.

### DETAILED DESCRIPTION

### Overview

As noted above, along with the development of automatic navigation technologies, the requirements for the accuracy of a GPS system have been sharply increased. In order to improve the accuracy of a GPS system for determining a location of an object such as a moving vehicle in real time, a mechanism for addressing or calibrating errors associated with a GPS signal in real time is needed.

This disclosure describes example GPS correction systems. The GPS correction system may receive GPS data from a plurality of stations (such as ground stations, stations floating in the air using balloons, etc.) equipped with a plurality of GPS receivers continuously or periodically. In response to receiving the GPS data, the GPS correction system may obtain an estimator using a filter-reweight-retrain robust algorithm. In implementations, the estimator may be used for estimating a vertical Total Electron Content (vTEC) value associated with a location coordinate in a GPS system.

By way of example and not limitation, in the filter-reweight-retrain robust algorithm, the GPS correction system may run one or more tests on the received GPS data to obtain at least a first dataset and a second dataset. The first dataset may include data points that pass the one or more tests, and the second dataset may include data points that fail the one or more tests. In some implementations, the second dataset may further include the first dataset. The one or more tests may include tests to separate or distinguish clean data points (i.e., data points having a low noise level) from noisy or corrupted data points (i.e., data points having a relatively high noise level). Examples of the one or more tests may include, but are not limited to, a closed loop test or an n-sigma test. In implementations, the GPS correction system may obtain an estimator based on an objective function using the first dataset in a single iteration (i.e., a first iteration) of training, and apply the trained estimator to the second dataset to obtain residual errors associated with data points of the second dataset.

In implementations, the GPS correction system may further obtain a third dataset after data points having corresponding residual errors greater than a specific threshold are removed from the second dataset. The GPS correction system may then retrain the estimator based on the objective function using the first dataset and the third dataset at another single iteration (i.e., a second iteration) of training.

In implementations, the GPS correction system may directly or indirectly receive a request for positioning service from a device at a certain location. The GPS correction system may estimate a corresponding vTEC value associated with the location of the device based at least in part on a plurality of vTEC values of the plurality of stations, the vTEC value being estimated using the retrained estimator that is trained. The GPS correction system may send information of the estimated vTEC value to the device to allow the device to correct an error of a GPS signal received by the device. In implementations, the error of the GPS signal is associated with an ionospheric delay.

In the examples described herein, the GPS correction system can obtain an estimator used for estimating a vTEC value associated with a location based on a filter-reweight-retrain robust algorithm using two iterations of training, thus significantly saving the time and cost of operations involved in the training. Therefore, the described GPS correction system not only can obtain a vTEC value for determining an ionospheric delay associated with a location of a device substantially in real time, but can also enable correcting a GPS signal for determining the location of the device substantially in real time, thus improving the accuracy of positioning of the device.

Furthermore, functions described herein to be performed by the GPS correction system may be performed by multiple separate systems or services. For example, in one embodiment, a training service may train an estimator based on GPS data received from a plurality of stations using a filter-reweight-retrain robust algorithm, while a receiving service may directly or indirectly receive a request for positioning service from a device at a certain location, and yet another service may allow estimate a vTEC value associated with the location of the device based at least in part on a plurality of vTEC values of the plurality of stations using the trained estimator, and send information of the estimated vTEC value to the device, and send information of the estimated vTEC value to the device, thus allowing the device to address an error associated with an ionospheric delay in a GPS signal received by the device to improve the accuracy of the GPS signal in determining the location of the device.

Moreover, although in the examples described herein, the GPS correction system may be implemented as software and/or hardware installed in a single device, in other examples, the GPS correction system may be implemented and distributed in multiple devices or as services provided in one or more stations and/or servers over a network and/or in a cloud computing architecture.

The application describes multiple and various embodiments and implementations. The following section describes an example framework that is suitable for practicing various implementations. Next, the application describes example systems, devices, and processes for implementing a GPS correction system.

### Example Environment

Prior to further discussing the GPS correction system, a mechanism for determining a location of an object using a GPS system is briefly introduced herein first.

A global navigation satellite system (GNSS) is a satellite navigation system that is able to provide positioning service with global coverage. Examples of the GNSS include GPS from the United States, GLONASS from Russia, BeiDou from China, and Galileo from the European Union. Given known positions of satellites in GNSS, a location of a device having a GPS receiver can be determined based on a high precision measurement of a distance between the device and a plurality of satellites (e.g., four or more satellites, etc.). In implementations, the distance may be calculated from a product of a time interval between a signal emitting from a satellite and a signal received by the device, and a speed of electromagnetic wave (e.g., microwave) transmission through a path from the satellite to the device.

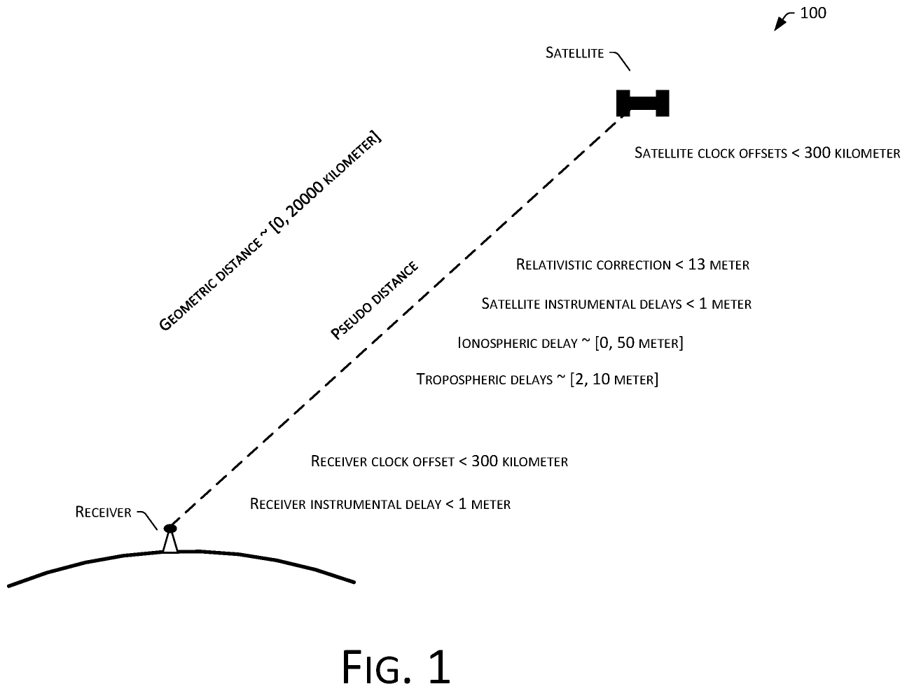

FIG. 1 shows major sources of errors along a path of microwave transmission in a high precision positioning system 100. A pseudo distance between a satellite and a GPS receiver is obtained through correlation between a modulated code in a signal received at the GPS receiver from the satellite and a same code generated in the GPS receiver. The pseudo distance may be affected by a plurality of temporal, frequency, and/or weather factors. Examples of these factors may include an Euclidean distance between a position of the satellite at signal emission and a position of the receiver at signal reception, offsets of respective clocks at the receiver and the satellite (which are clock synchronization errors of the receiver and satellite with respect to a GPS time), a relativistic correction, a tropospheric delay (which is frequency dependent), an ionospheric delay (which is frequency dependent), an instrumental delay (which is frequency dependent), and a multi-path effect.

In implementations, a double differencing and multi-frequency method may be performed on the GPS signal to determine and/or address factors due to errors associated with the clock offsets and the instrumental delay. The double differencing and multi-frequency method is known in existing technologies and is therefore not described herein. Additionally, in implementations, orbital and atmospheric biases or errors (such as the relativistic correction and the tropospheric delay) may be reduced or eliminated due to similar path of transmission.

After the double differencing and multi-frequency method is applied on the GPS signal, a remaining error is dominated by the ionospheric delay. The ionosphere is located in the upper atmosphere of the Earth, and may be modeled as a thin layer of ionized electrons at about 350 kilometers above the sea level. A vertical Total Electron Content (vTEC) is an important descriptive parameter of the ionosphere, which integrates the total number of electrons along a perpendicular path through the ionosphere. An additional phase and a group delay of an electromagnetic wave signal (such as a microwave signal) that are accumulated during transmission of the electromagnetic wave signal through the ionosphere are proportional to the vTEC. A value of vTEC is impacted by nearly unpredictable solar flare which inherently causes high temporal and spatial fluctuations to vTEC values at different times and spaces. In the present disclosure, the GPS correction system enables estimating a vTEC value at any location, thus allowing a device to address or calibrate an error associated with an ionospheric delay to improve the accuracy of a GPS signal in determining a location of the device.

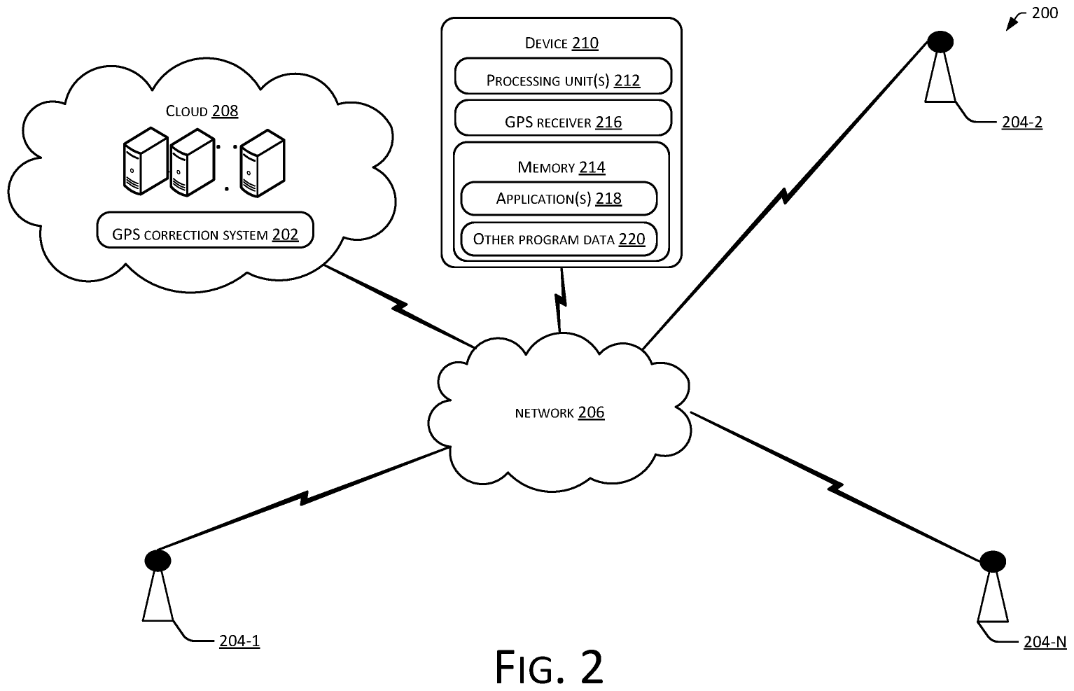

FIG. 2 illustrates an example environment 200 usable to implement a GPS correction system. The environment 200 may include a GPS correction system 202. In implementations, the environment 200 may further include a plurality of stations 204-1, 204-2, . . . , 204-N (which are collectively called as stations 204), each station 204 having one or more GPS receivers, where N is an integer greater than one. The plurality of stations 204 may be set up or deployed in different locations. A location of a station 204 may be fixed or movable. In implementations, the plurality of stations 204 may be distributed according to a predefined topology (e.g., a grid layout, etc.) or in a random or semi-random manner within a particular region. The GPS correction system 202 may communicate data with the plurality of stations 204 through a network 206. Additionally, the environment 200 may further include a cloud 208 of server computers. In implementations, the environment 200 may further include a device 210, of which a location is to be determined.

In this example, the GPS correction system 202 is described to be included in the cloud 208. However, in other instances, the GPS correction system 202 may be an entity independent or separate from the cloud 208. For example, the GPS correction system 202 may be included in and/or distributed among one or more stations 204, which may communicate data with one another and/or with the cloud 208 via the network 206. Additionally or alternatively, in some instances, functions of the GPS correction system 202 may be included in and/or distributed among one or more servers of the cloud 208 and one or more stations 204. For example, the one or more servers of the cloud 208 may include part of the functions of the GPS correction system 202 while other functions of the GPS correction system 202 may be included in the one or more stations 204. In some instances, the device 210 may include some functions of the GPS correction system 202.

The device 210 may be implemented as any of a variety of devices having a GPS receiver or being attached or associated with a peripheral device that includes a GPS receiver. Examples of the device 210 may include, but are not limited to, a notebook or portable computer, a handheld device, a netbook, an Internet appliance, a tablet or slate computer, a mobile device (e.g., a mobile phone, a personal digital assistant, a smart phone, etc.), a navigation system (e.g., a vehicle navigation system, an aircraft navigation system, a marine navigation system, etc.), or a combination thereof.

The network 206 may be a wireless or a wired network, or a combination thereof. The network 206 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc.

In implementations, the device 210 may include one or more processors or processing units 212, memory 214, and a GPS receiver 216. The one or more processors or processing units 212 may be implemented as one or more hardware processors including, for example, a microprocessor, an application-specific instruction-set processor, a graphics processing unit, a physics processing unit (PPU), a central processing unit (CPU), a graphics processing unit (GPU), a digital signal processor, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 214 may include or store one or more application(s) 218 (e.g., a positioning application, etc.) that are executable by the one or more processing processors or units 212, and other program data 220. The memory 214 may be coupled to, associated with, and/or accessible to other devices, such as network servers, routers, through the network 206.

The memory 214 may include computer-readable media in a form of volatile memory, such as Random Access Memory (RAM) and/or non-volatile memory, such as read only memory (ROM) or flash RAM. The memory 214 is an example of computer-readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves. In implementations, the device 210 may further include an input/output interface, a network interface, and a display (not shown).

In implementations, the application(s) 218 (such as the positioning application) of the device 210 communicates with the GPS receiver 216 to receive a GPS signal for determining a current location of the device 210. The application 218 or the device 210 may send or broadcast a request for positioning service to the GPS correction system 202 through the network 206. Depending on where the GPS correction system 202 is located, the application(s) 218 or the device 210 may send or broadcast the request for positioning service to one or more stations 204 and/or the cloud 208. In implementations, the request may include the GPS signal, and may further include identification information of the device 210 so that the GPS correction system 202 can know to which device a result of the request is sent. In response to receiving the request from the device 210, the GPS correction system 202 may estimate a vTEC value associated with the current location of the device 210 based on the received GPS signal using an estimator. The GPS correction system 202 may send information of an estimated vTEC value to the device 210 through the network 206. The device 210 may then correct the GPS signal using the information received from the GPS correction system 202, and determine the current location of the device based at least on the corrected GPS signal.

### Example GPS Correction System

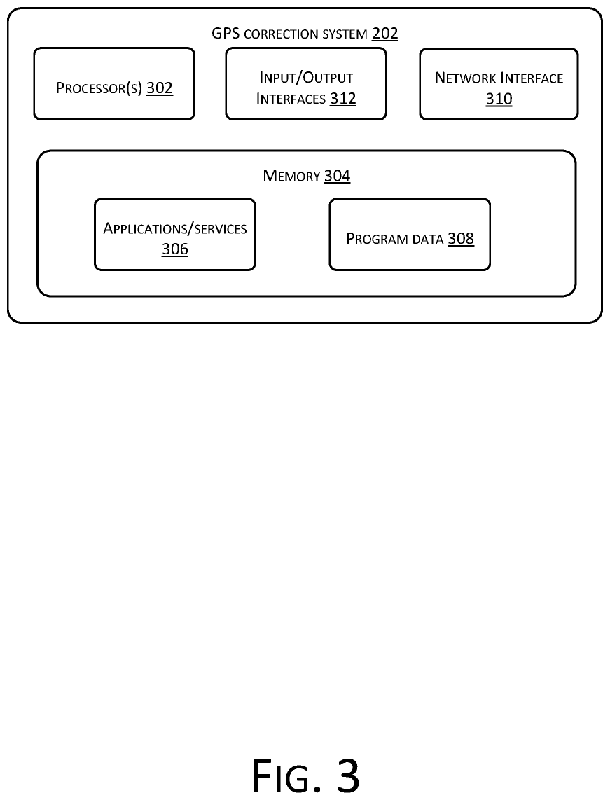

FIG. 3 illustrates the GPS correction system 202 in more detail. In implementations, the GPS correction system 202 includes, but is not limited to, one or more processors 302, memory 304, one or more applications or services 306 (e.g., a GPS correction application or service, etc.) and program data 308. In implementations, the GPS correction system 202 may further include a network interface 310 and an input/output interface 312. The processor(s) 302 is configured to execute instructions received from the network interface 310, received from the input/output interface 312, and/or stored in the memory 304. The memory 304 is an example of computer-readable media as described in the foregoing description.

### Example Methods

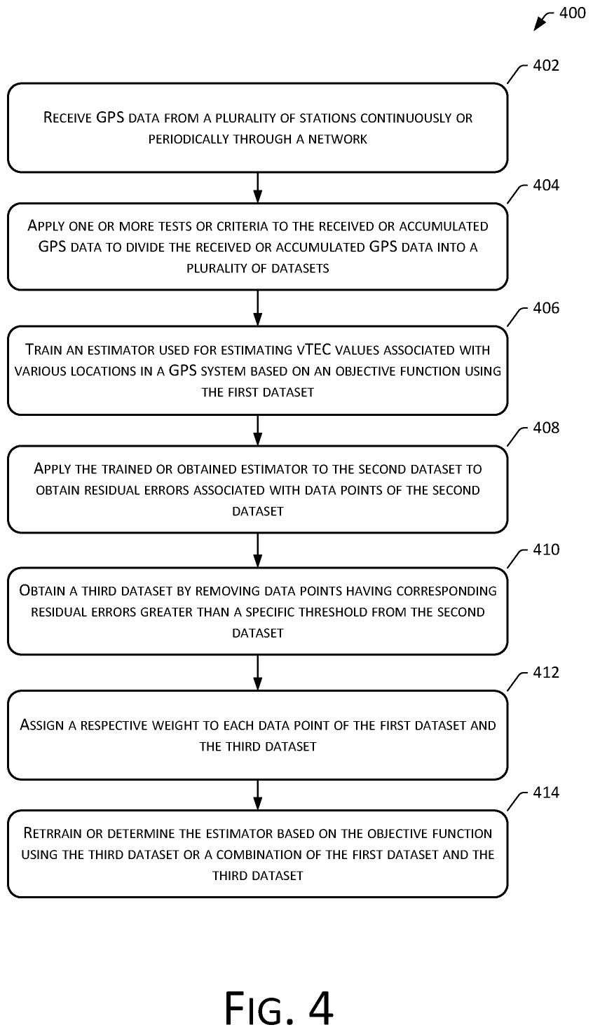

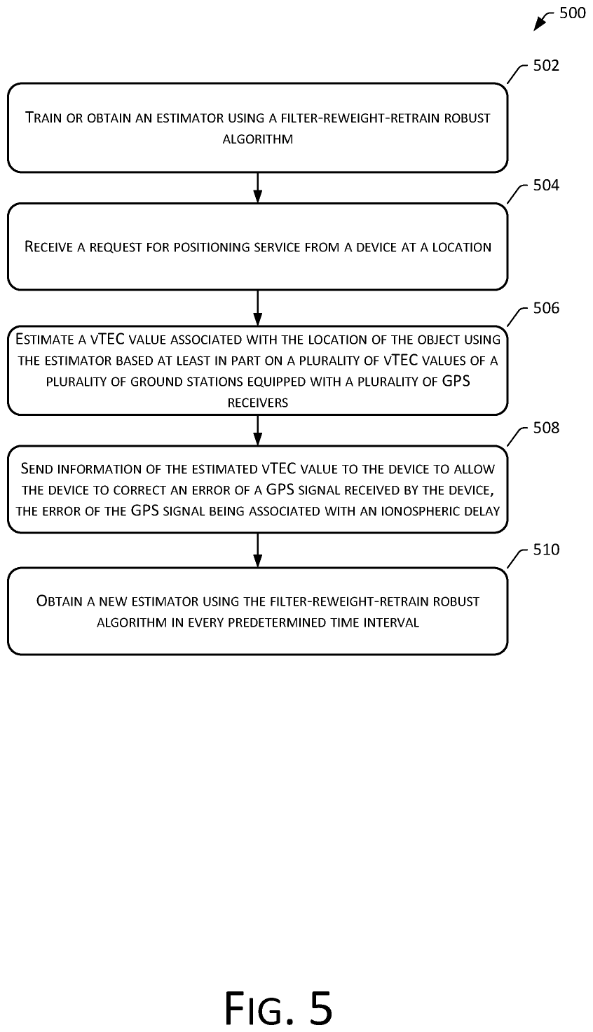

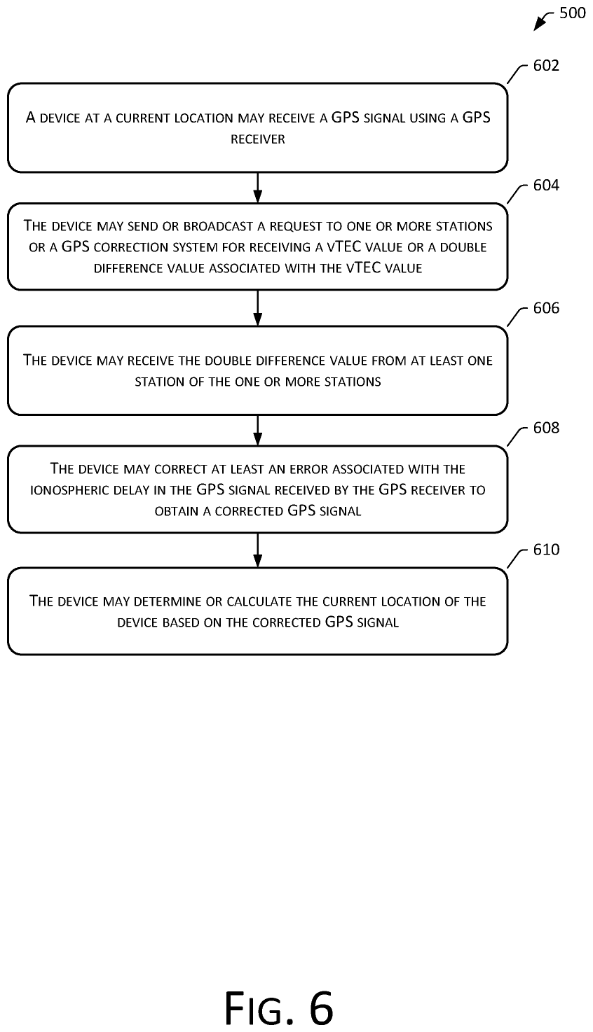

FIG. 4 is a flowchart depicting a method of training an estimator for estimating a vTEC value at a location. FIG. 5 is a flowchart depicting a method of providing information of a vTEC value for correcting a GPS signal. FIG. 6 is a flowchart depicting a method of correcting a GPS signal. The methods of FIGS. 4-6 may, but need not, be implemented in the environment of FIG. 2 and using the system of FIG. 3. For ease of explanation, methods 400-600 described with reference to FIGS. 2-3. However, the methods 400-600 may alternatively be implemented in other environments and/or using other systems.

Methods 400-600 are described in the general context of computer-executable instructions. Generally, computer-executable instructions can include routines, programs, objects, components, data structures, procedures, modules, functions, and the like that perform particular functions or implement particular abstract data types. Furthermore, the example method is illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring to FIG. 4, at block 402, the GPS correction system 202 may receive GPS data from the plurality of stations 204 continuously or periodically through the network 206. In implementations, the GPS data may include GPS signals received by the GPS receivers of the plurality of stations 204. In implementations, the GPS correction system 202 may accumulate GPS signals received by the GPS receivers of the plurality of stations 204 over a predetermined period of time, e.g., one second or less. In implementations, since the locations of the plurality of stations 204 are known, true or noise-free GPS data for the plurality of stations is known or can be reciprocally determined.

At block 404, the GPS correction system 202 may apply one or more tests or criteria to the received or accumulated GPS data to divide the received or accumulated GPS data into a plurality of datasets, such as a first dataset and a second dataset. In implementations, the one or more tests or criteria are used for separating or distinguishing data points having low noise levels (such as clean data points having low or minimal noises) from data points having relatively high noise levels (such as noisy or corrupted data points having a large amount of noises) in the received or accumulated GPS data. By way of example and not limitation, the one or more tests or criteria may include, but are not limited to, a closed loop test, or an n-sigma test. In this example, the first dataset corresponds to a set of data points that pass the one or more tests, and the second dataset correspond to a set of data points that fail the one or more tests.

At block 406, the GPS correction system 202 trains an estimator used for estimating vTEC values associated with various locations in a GPS system based on an objective function using the first dataset. By way of example and not limitation, the GPS correction system 202 trains or obtains the estimator by minimizing the objective function using the first dataset. In implementations, the objective function may include, but is not limited to, a convex loss function, such as a least square loss function.

At block 408, the GPS correction system 202 may apply the trained or obtained estimator to the second dataset to obtain residual errors associated with data points of the second dataset.

At block 410, the GPS correction system 202 may obtain a third dataset by removing data points having corresponding residual errors greater than a specific threshold from the second dataset. In implementations, the specific threshold may depend on an average of the residual errors associated with the data points of the second dataset. In other implementations, the specific threshold may be predetermined or fixed in advance.

At block 412, the GPS correction system 202 may optionally assign a respective weight to each data point of the first dataset and the third dataset. In implementations, the respective weight of each data point of the first dataset and the third dataset is dependent on a residual error associated with the respective data point obtained when the estimator is applied to each data point of the first dataset and the third dataset.

At block 414, the GPS correction system 202 may retrain or determine the estimator based on the objective function using the third dataset or a combination of the first dataset and the third dataset. By way of example and not limitation, the GPS correction system 202 may determine an estimator that minimizes the objective function using the third dataset or the combination of the first dataset and the third dataset. In some implementations, if a respective weight has been assigned to each data point of the first dataset and the third dataset prior to the retraining, the GPS correction system 202 may retrain or determine the estimator based further on the respective weight of each data point of the third dataset or the combination of the first dataset and the third dataset. The retrained estimator obtained by the GPS correction system 202 is therefore ready for use in determining a vTEC value associated with a GPS signal received by an object at any location.

Referring to FIG. 5, at block 502, the GPS correction system 202 may train or obtain an estimator using a filter-reweight-retrain robust algorithm as described in the foregoing description and FIG. 4, for example.

At block 504, the GPS correction system 202 may receive a request for positioning service from a device (e.g., the device 210) at a location. The device may include, but is not limited to, a device including a GPS receiver or having a peripheral accessory including a GPS receiver.

At block 506, the GPS correction system 202 may estimate a vTEC value associated with the location of the object using the estimator based at least in part on a plurality of vTEC values of a plurality of ground stations equipped with a plurality of GPS receivers.

At block 508, the GPS correction system 202 may send information of the estimated vTEC value to the device to allow the device to correct an error of a GPS signal received by the device, the error of the GPS signal being associated with an ionospheric delay. In implementations, the information of the estimated vTEC value may include a double difference value obtained based on the estimated vTEC value and relationships between locations of the plurality of ground stations and the location of the device.

At block 510, the GPS correction system 202 may obtain a new estimator using the filter-reweight-retrain robust algorithm in every predetermined time interval. Specifically, the GPS correction system 202 may repeat blocks 502-508 to obtain a new estimator. In implementations, the predetermined time interval may be one second or less. In other implementations, the predetermined time interval may depend on time of day, location and/or weather. For example, the predetermined time interval is shorter in time during a time period in which vTEC values (or errors associated with ionospheric delays) fluctuate relatively frequently as compared to other time periods during which vTEC values (or errors associated with ionospheric delays) fluctuate less frequently.

Although the GPS correction system 202 is described to train or obtain an estimator using a filter-reweight-retrain robust algorithm periodically or prior to receiving a request for positioning service from a device in the examples described herein, in some implementations, the GPS correction system 202 may train or obtain an estimator using a filter-reweight-retrain robust algorithm in response to receiving a request for positioning service from a device.

Referring to FIG. 6, at block 602, a device (such as the device 210) at a current location may receive a GPS signal using a GPS receiver. The GPS signal that includes an error associated with an ionospheric delay.

At block 604, the device may send or broadcast a request to one or more stations (such as the stations 204) or the GPS correction system 202 for receiving a vTEC value or a double difference value associated with the vTEC value. The vTEC value or the double difference value can be used by the device for calibrating or correcting the error associated with the ionospheric delay in the GPS signal. In implementations, the vTEC value or the double difference value can be estimated by an estimator that is trained using a filter-reweight-retrain robust algorithm as described in the foregoing description and FIG. 4, for example. In implementations, the request may include the GPS signal received by the GPS receiver of the device.

At block 606, the device may receive the double difference value from at least one station of the one or more stations.

At block 608, the device may correct at least an error associated with the ionospheric delay in the GPS signal received by the GPS receiver to obtain a corrected GPS signal.

At block 610, the device may determine or calculate the current location of the device based on the corrected GPS signal.

In implementations, the device may perform the above method as described in blocks 602-610 in substantially real time, or in every second or less.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media.

### Filter-Reweight-Retrain Robust Algorithm

In order to further understand the filter-reweight-retrain robust algorithm, the algorithm is described hereinafter in more detail using example conditions (such as an example objective function, etc.). The filter-reweight-retrain robust algorithm is a meta algorithm that is applicable to any base estimators having a decision value as an output. For the sake of brevity, a d dimensional linear space is used hereinafter for illustration. Following standard setting, data points x∈ [symbol] ^{d} are sampled from sub-Gaussian distribution such that:

[symbol]

x=0, ∥x∥₂≤c\sqrt{d log(2d/η)}, [symbol] xx^{T}=I

where c is a universal constant, and 0<η<1. A label y∈ [symbol] is a real number.

Two datasets including (x, y) pairs, namely a clean set S and a noisy set Ŝ are given. Both sets are assumed to be independently and identically sampled. In the clean set S,

y= [symbol] ω*,x [symbol] +ξ∀(x, y)∈S.

ξ, which is a noise term, may be independently and identically sampled from a sub-Gaussian distribution having a mean as zero, a variance proxy as σ, and a boundary for ξ as |ξ|≤ξₘₐₓ.

In the noisy set Ŝ, an observed label may be corrupted by a noise model,

ŷ= [symbol] ω*,\hat{x} [symbol] +\hat{ξ}∀(\hat{x},ŷ)∈Ŝ.

\hat{ξ}, which is a noise term, may be independently and identically sampled from a heavy-tailed distribution. Since a mean value of ξ may not exist, directly learning on Ŝ may be impossible.

Without loss of generality, a distribution of \hat{ξ} may be assumed to be symmetric in nature. If not, a bias term may be added in a linear regression model to capture this offset. A size of the clean set S is denoted as n=|S|, and a size of the noisy set Ŝ is denoted as m=|Ŝ|. |Ŝ|/(|S|+|Ŝ|) is a noise ratio of a full dataset which includes the clean set S and the noisy set Ŝ. In implementations, a linear least square regression may be used as a base estimator, which can be defined as:

$$\hat{ω} = {arg min}_{ω} 𝓁 ( S \vert ω ) {=}^{Δ} {\sum }_{( x . y 〉 ∈ S} {( 〈 ω , x 〉 - y )}^{2}$$

A recovery error ∥\hat{ω}−ω*∥₂ may be used as a performance index.

An example filter-reweight-retrain robust algorithm is provided in Table 1 as follows.

TABLE 1
Algorithm: Filter-Reweight-Retrain Robust Algorithm

Input: Clean Set S, Noisy Set Ŝ, Truncation Threshold τ, and a
reweighting function h(·)
Process: Robust Estimation ω̅
1: ${ω}^{init} = {arg min}_{ω} 𝓁 ( S \text{\textbar} ω )$
2: rᵢ = | [symbol] ω^{init},\hat{x}⁽ⁱ⁾ [symbol] − ŷ⁽ⁱ⁾|, ∀(\hat{x}⁽ⁱ⁾, ŷ⁽ⁱ⁾) ∈ S
3: Ŝ′ = {(\hat{x}, ŷ)|| [symbol] ω^{init}, \hat{x} [symbol] − ŷ| ≤ τ, ∀(\hat{x}, ŷ) ∈ Ŝ}
4: αᵢ = h(rᵢ) if ∀x⁽ⁱ⁾ ∈ Ŝ′, otherwise αᵢ = 1
5: Retrain ω̅ using a weighted least square loss function
$\overline{ω} = {arg min}_{ω} {\sum }_{( {x}^{( i )} , {y}^{( i )} ) ∈ SU \hat{{S}^{′}}} {{a}_{i} ( 〈 ω , {x}^{( i )} 〉 - {y}^{( i )} )}^{2}$
Output: ω̅

Specifically, an initial estimator is first trained using the clean dataset S. A residual error rᵢ is computed for each data point in the noisy dataset Ŝ. Any \hat{x}∈Ŝ having a residual error that is greater than a threshold τ is filtered or removed. The noisy dataset Ŝ after filtering is denoted as Ŝ′. An instance weight αᵢ is assigned for each x⁽ⁱ⁾∈Ŝ′. A robust estimation of ω̅ is obtained by retraining the weighted least square loss function.

In implementations, the threshold τ and the instance weights αᵢ may be adaptively selected, so that a recovery error can be minimized. In implementations, if the size of the noisy set Ŝ is infinite, the threshold τ may be selected to be sufficiently large, and αᵢ=1. The recovery error in this case will be asymptotically zero. If the size of the noisy set Ŝ is finite, τ=c₁Σᵢrᵢ/m and αᵢ=c₂ exp(rᵢ/c₃), wherein {c₁,c₂,c₃} are tuned by cross-validation. In implementations, a filtering and reweighting method may be designed based on prior knowledge of distribution of noises in the clean dataset and the noisy dataset.

Although a linear estimator and a least square loss function are used in the above examples, the filter-reweight-retrain robust algorithm is a meta algorithm that is also applicable to non-linear kernel function and a general convex loss function. In this case, the feature vector x may be replaced by ψ(x), wherein ψ(•) is a feature map function induced by the kernel function, and an inner product [symbol] ω,x [symbol] can be replaced by a corresponding inner product defined on a Reproducing Hilbert Kernel Space (RHKS). For the sake of brevity and without loss of generality, a linear model is used herein to continue illustrating some properties of the filter-reweight-retrain robust algorithm.

Lemma 1: In the filter-reweight-retrain robust algorithm, with probability at least 1−η, ∥ω^{init}−ω*∥₂≤c²σ\sqrt{d}[log(2d/η)]^{3/2}/\sqrt{|S|} [symbol] Δ, provided that |S|≥max{(ξₘₐₓ/σ)², 4d log²(2d/η)/c⁶)}.

Lemma 1 shows that the initial estimator is not far away from ground truth ω*, as long as the clean dataset is sufficiently large. The filter-reweight-retrain robust algorithm only requires the size of the clean dataset |S| to be no less than [symbol] (d log d). Since \hat{ξ} is assumed to be heavy-tailed in the current example, a variance of \hat{ξ} is needed to be bounded first prior to performing any learning on the noisy dataset. Therefore, the filter-reweight-retrain robust algorithm employs ω^{init} to truncate \hat{ξ} via instance filtering.

After filtering at line 3 of the filter-reweight-retrain robust algorithm in Table 1, for any \hat{x}′∈Ŝ′, Lemma 2 is obtained.

Lemma 2: In the filter-reweight-retrain robust algorithm, with probability at least 1−2η, |\hat{ξ}ᵢ|≤rᵢ+cΔ\sqrt{log (2/η)} ∀\hat{x}⁽ⁱ⁾∈Ŝ′.

Lemma 2 shows that a noise level on Ŝ′ can be truncated or reduced to below 2τ when τ≥Δ\sqrt{log(2/η)}. Due to independence of ω^{init} and \hat{x}⁽ⁱ⁾∈Ŝ′,Ŝ′ cannot be retrained twice. In a second iteration or round of training, since a previous ω depends on x⁽ⁱ⁾, a bound |ω^{T}x⁽ⁱ⁾| will be degraded to [symbol] (d/\sqrt{|S|}), which requires |S|≥ [symbol] (d²). However, if the clean dataset is larger than [symbol] (d²), the initial estimator is already good enough and no retraining is needed at that point.

After filtering, a bounded noise distribution on Ŝ′, is obtained, thus allowing learning. |Ŝ′|=m after filtering. Sample weight α=[α₁, α₂, . . . , αₘ] are computed via h(rᵢ). The following theorem bounds a recovery error after retraining.

Theorem 1: In the filter-reweight-retrain robust algorithm, denote |S|=n, |Ŝ′|=m. {α₁, α₂, . . . , αₘ} are weights of elements in Ŝ′, αₘᵢₙ≤αᵢ≤αₘₐₓ. x⁽ⁱ⁾,\hat{x}⁽ⁱ⁾ are sub-Gaussian random vectors with a bounded norm ∥x⁽ⁱ⁾∥₂,∥\hat{x}⁽ⁱ⁾∥₂≤c\sqrt{d log(2/η)}, where c>0 is a universal constant, 0<η<1. Define

σ̅₁² [symbol] ∥ [symbol] \hat{ξ}ᵢ²αᵢ²\hat{x}⁽ⁱ⁾\hat{x}^{(i)T}∥₂

α̅ [symbol] [symbol] {∥αᵢ\hat{x}⁽ⁱ⁾\hat{x}^{(i)T}∥₂}

Then, with probability at least 1−3η,

∥ω̅−ω*∥₂≤[½n+mαₘᵢₙ−c³α̅\sqrt{md} log(2d/η)]⁻¹{c²σ\sqrt{nd}[log(2d/η)]^{3/2}+σ̅₁\sqrt{m log(2d/η)}} (2)

provided

n≥max{(ξnₘₐₓ/σ)², 4d log²(2d/η)/c⁶}

m≥d log²(2d/η)max{[αₘₐₓ(τ+)cΔ\sqrt{log(2/η)}/σ̅₁]²c⁶(α̅/αₘᵢₙ)²,(αₘₐₓ/α̅)²}

Based on Theorem 1 as described above, a recovery error of the filter-reweight-retrain robust algorithm is bounded by [symbol] [(σ\sqrt{n}+σ̅₁\sqrt{m})/(n+mαₘᵢₙ)]. A choice of αᵢ=h(rᵢ)WO is important. If αᵢ depends on rᵢ, [symbol] αᵢ\hat{x}⁽ⁱ⁾\hat{x}⁽ⁱ⁾=I may not be taken, and there may be no closed-form tight upper bound in Theorem 1. Constants {σ̅₁²,α̅} are defined to capture such dependency. In the most simple scenario, αᵢ=α, where α is a fixed constant that is independent from Ŝ. A recovery error of the filter-reweight-retrain robust algorithm is then bounded by [symbol] [\sqrt{σn+α²\hat{σ}²m}/(n+αm)], where \hat{σ}² is a variance of truncated noise in Ŝ. Therefore, for a fixed reweighting function h(rᵢ)=α, a recovery error is decreased when m is increased, and \hat{σ}, which is controlled by τ, is increased at a lower rate. If prior knowledge about a distribution of noise term \hat{ξ} is known, τ can be selected in a way to minimized the above error bound.

Based on Theorem 1, the following rules are provided:

Rule 1: The reweighting function h(•) depends on rᵢ only, i.e., αᵢ=h(rᵢ), and αᵢ does not depend on other rⱼ, where j≠i. This rule ensures that {αᵢ}ᵢ₌₁^{m} are independent to each other, so that Σᵢαᵢ\hat{x}⁽ⁱ⁾\hat{x}⁽ⁱ⁾ is concentrated around a mean value thereof. In implementations, this rule may prohibit jointly and iteratively optimizing {αᵢ}ᵢ₌₁^{m}.

Rule 2: The maximum of h(•) is bounded. This rule avoids the reweighting process from assigning a large weight for a single instance.

### Example Scenario/Application

An example scenario is given herein for further understanding of applications of the filter-reweight-retrain robust algorithm in correcting a GPS signal. In this example, a Network-based Real-time Kinematic (RTK) carrier-phase DGNSS receiver system is used to achieve high-precision (e.g., centimeter-level) positioning service. A triangular mesh grid of a number (such as 20 in this example) of satellite stations spaced by a predefined distance (e.g., 75 km in this example) distributed over a certain area (such as 100,000 squared kilometers in this example). The satellite stations can receive and process signals of satellites from all four major GNSS systems. In this example, all the satellite stations are equipped with dual-frequency receivers.

When the satellites orbit above horizon with a high elevation angle (for example, greater than 15 degrees), each receiver-satellite pair forms a Pierce Point on the ionosphere. Data received by the stations can be sent to a central processing facility hosted on the cloud to fit a model for vTEC pseudo distance compensation.

In the present example, a dataset consisting of ten consecutive days are collected. Data of the first five days are used as a training set, and data of the remaining five days are used as a testing set. Table 2 shows statistics of the dataset.

TABLE 2

| Dataset | Size of clean data | Size of noisy data | Noisy ratio |
|---|---|---|---|
| TrainDay1 | 17751091 | 4288037 | 19.5% |
| TrainDay2 | 17443691 | 4618126 | 20.9% |
| TrainDay3 | 16198561 | 5851525 | 26.5% |
| TrainDay4 | 17091968 | 5042280 | 22.8% |
| TrainDay5 | 15807494 | 6305344 | 28.5% |
| TestDay1 | 16292229 | 5605534 | 25.6% |
| TestDay2 | 15048558 | 6983814 | 31.7% |
| TestDay3 | 14616549 | 7327788 | 33.4% |
| TestDay4 | 15191055 | 6849075 | 31.1% |
| TestDay5 | 13616039 | 8374171 | 38.1% |

As shown in the above table, if noisy data is filtered and not used in estimation of vTEC values, about 30% of data points will be filtered, causing a great waste of data collected by the stations.

In this example, one of the satellite stations is selected as a testing station, and 16 other satellite stations are selected as training stations. A RTK ratio is used as an index. The RTK ratio is the probability of successful positioning wherein an error of positioning is less than one centimeter. The higher the RTK ratio is, the higher the probability of successful positioning will be. The RTK ratio largely depends on double differences that are predicted for the testing station.

As the current RTK carrier-phase DGNSS receiver system is a real-time online system, the total time cost of model training and prediction is configured not to exceed a predetermined time duration per second frame. In this example, the predetermined time duration is set as 300 milliseconds. A Gaussian Process (GP) is used as a base estimator. In the GP model, a vTEC value for each pierce point is denoted as ƒᵢ, wherein i=1, 2, . . . , n. A matrix A encodes a double-difference quadruplet, in which each row of A has exact two “1” entries and two “−1” entries where a corresponding ionosphere pierce point is involved in an associated double difference calculation. Each ionosphere pierce point is represented as a four-dimensional vector x=[x₁,x₂,x₃,x₄]∈ [symbol] ⁴. {x₁,x₂} encode the latitude and the longitude of the respective pierce point. x₃ is an elevation angle, and x₄ is an azimuth angle. In this example, a kernel function is defined as:

κ(x,x′) [symbol] exp{−(x−x′)^{T}Ω⁻¹(x−x′)}

where Ω=diag(ω₁,ω₂,ω₃,ω₄) is a diagonal kernel parameter matrix.

The kernel matrix induced by κ is K∈ [symbol] ^{n×n}, where Kᵢⱼ [symbol] κ(x⁽ⁱ⁾,x^{(j)}). y is denoted as a double difference value. In the GP model, the following loss function is minimized:

$${min}_{f} {‖ Af - y ‖}^{2} + λ {y}^{T} {K}^{- 1} f \qquad ( 1 )$$

In every second, the above equation (1) is solved using data points collected by the training stations. To predict a vTEC value for each pierce point on the testing station, the following equation is used:

ƒ_{pred}=Σᵢ₌₁ⁿκ(x⁽ⁱ⁾,x^{pred})ƒᵢ

A double difference value can be calculated according to A_{pred}ƒ_{pred}, wherein A_{pred} is a quadruplet matrix of the testing station.

In an offline stage, model parameters are tuned using the training data of the first five days. Kernel parameters ω₁ and ω₂ are tuned in a range of [0.001, 1000]. Kernel parameters ω₃ and ω₄ are tuned in a range of [0.01,π/2]. λ is tuned in a range of [10⁻⁶, 10⁶]. To apply the filter-reweight-retrain robust algorithm, equation (2) is trained on a clean dataset (i.e., a first dataset). A model (i.e., an estimator) learned thereby is then applied on a noisy dataset (i.e., a second dataset) to predict y_{pred} and an absolute residual error r=|y^{pred}−y| is calculated. Given that a reweighting parameter c₁ is tuned in a range of [0.5, 8], an i^{th} noisy data point is reserved in the training if rᵢ≤c₁Σᵢ₌₁ⁿrᵢ/n. Otherwise, the i^{th} noisy data point is discarded. In this example, a reweighting parameter c₂ is tuned in a range of [0.01, 1], and a reweighting parameter c₃ is tuned in a range of [0.001, 0.1]. The model of Equation (2) is then retrained using the filtered noisy dataset (i.e., a third dataset) and the clean dataset (i.e., the first dataset). A retrained model (i.e., a retrained estimator) can then be ready for use in estimating a vTEC value or a double difference value for a certain location.

### Conclusion

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by a system, the system comprising: receiving a request for positioning service from a computing device at a location; estimating a Total Electron Content (vTEC) value associated with the location of the object based at least in part on a plurality of vTEC values of a plurality of ground stations equipped with a plurality of GPS receivers, the vTEC value being estimated based on an estimator that is trained using a filter-reweight-retrain robust algorithm; and sending information of the estimated vTEC value to the computing device to allow the computing device to correct an error of a GPS signal received by the computing device, the error of the GPS signal being associated with an ionospheric delay.

Clause 2: The method of Clause 1, wherein the filter-reweight-retrain robust algorithm comprises: training the estimator based on an objective function using a first dataset, the first dataset comprising data points that pass a particular test; applying the estimator to a second dataset to obtain residual errors associated with data points of the second dataset, the data points of the second dataset comprising data points that fail the particular test with or without the first dataset; obtaining a third dataset by removing data points having corresponding residual errors greater than a specific threshold from the second dataset; and retraining the estimator based on the objective function using the third dataset or a combination of the first dataset and the third dataset.

Clause 3: The method of Clause 2, further comprising performing the filter-reweight-retrain robust algorithm to obtain a new estimator in every predetermined time interval.

Clause 4: The method of Clause 3, wherein the predetermined time interval comprises one second or less.

Clause 5: The method of Clause 2, wherein the specific threshold depends on an average of the residual errors associated with the data points of the second dataset.

Clause 6: The method of Clause 2, further comprising assigning a respective weight to each data point of the first dataset and the third dataset prior to retraining the estimator based on the objective function using the third dataset or the combination of the first dataset and the third dataset, the respective weight of each data point of the first dataset and the third dataset being dependent on a residual error associated with the respective data point obtained when the estimator is applied prior to the retraining.

Clause 7: The method of Clause 1, wherein the information of the estimated vTEC value comprises a double difference value obtained based on the estimated vTEC value and relationships between locations of the plurality of ground stations and the location of the computing device.

Clause 8: The method of Clause 1, wherein the system comprises a cloud computing system connected to the plurality of ground stations, or a ground station of the plurality of ground stations.

Clause 9: One or more computer readable media storing executable instructions that, when executed by one or more processors, cause the one or more processors to perform acts comprising: training an estimator based on an objective function using a first dataset, the first dataset comprising data points that pass a particular test; applying the estimator to a second dataset to obtain residual errors associated with data points of the second dataset, the data points of the second dataset comprising data points that fail the particular test with or without the first dataset; obtaining a third dataset by removing data points having corresponding residual errors greater than a specific threshold from the second dataset; and retraining the estimator based on the objective function using the third dataset or a combination of the first dataset and the third dataset, wherein the estimator is applied to estimate a vertical Total Electron Content (vTEC) value associated with a location coordinate in a Global Positioning System (GPS).

Clause 10: The one or more computer readable media of Clause 9, wherein the objective function comprises a convex loss function.

Clause 11: The one or more computer readable media of Clause 9, wherein the particular test comprises at least one of a closed loop test or an n-sigma test.

Clause 12: The one or more computer readable media of Clause 9, the acts further comprising determining a double difference value from the vTEC value, the double difference value being used to correct an estimated value of the location coordinate obtained using the GPS.

Clause 13: The one or more computer readable media of Clause 9, wherein retraining the estimator based on the objective function using the third dataset or the combination of the first dataset and the third dataset comprises determining an estimator that minimizes the objective function using the third dataset or the combination of the first dataset and the third dataset.

Clause 14: The one or more computer readable media of Clause 9, wherein the specific threshold depends on an average of the residual errors associated with the data points of the second dataset.

Clause 15: The one or more computer readable media of Clause 9, the acts further comprising assigning a respective weight to each data point of the first dataset and the third dataset prior to retraining the estimator based on the objective function using the third dataset or the combination of the first dataset and the third dataset, the respective weight of each data point of the first dataset and the third dataset being dependent on a residual error associated with the respective data point obtained when the estimator is applied prior to the retraining.

Clause 16: The one or more computer readable media of Clause 9, the acts further comprising: obtaining a new first dataset and a new second dataset; and repeating the training, the applying, the obtaining, and the retraining using at least the new first dataset and the new second dataset.

Clause 17: The one or more computer readable media of Clause 9, wherein at least some of data points of the first dataset and the data points of the second dataset are associated with location coordinates that are different from the location coordinate associated with the vTEC value.

Clause 18: A computing device comprising: a Global Positioning System (GPS) receiver configured to receive a GPS signal; one or more processors; memory storing executable instructions that, when executed by the one or more processors, cause the one or more processors to perform acts comprising: sending a request to one or more ground stations for receiving a double difference value estimated by an estimator that is trained using a filter-reweight-retrain robust algorithm, the double difference value being caused by an ionospheric delay; receiving the double difference value from at least one ground station of the one or more ground stations; and correcting at least an error associated with the ionospheric delay in the GPS signal received by the GPS receiver to obtain a corrected GPS signal; and determining the current location of the computing device based on the corrected GPS signal.

Clause 19: The computing device of Clause 18, wherein the sending, the receiving, the correcting and the determining are performed in substantially real time, or in every second or less.

Clause 20: The computing device of Clause 18, wherein the filter-reweight-retrain robust algorithm comprises: training the estimator based on an objective function using a first dataset, the first dataset comprising data points that pass a particular test; applying the estimator to a second dataset to obtain residual errors associated with data points of the second dataset, the data points of the second dataset comprising data points that fail the particular test with or without the first dataset; obtaining a third dataset by removing data points having corresponding residual errors greater than a specific threshold from the second dataset; and retraining the estimator based on the objective function using the third dataset or a combination of the first dataset and the third dataset.

What is claimed is:

1. A method implemented by a system, the method comprising:
receiving a request for positioning service from a computing device at a location;
estimating a Total Electron Content (vTEC) value associated with the location of the object based at least in part on a plurality of vTEC values of a plurality of ground stations equipped with a plurality of GPS receivers, the vTEC value being estimated based on an estimator that is trained using a filter-reweight-retrain robust algorithm; and
sending information of the estimated vTEC value to the computing device to allow the computing device to correct an error of a GPS signal received by the computing device, the error of the GPS signal being associated with an ionospheric delay.

2. The method of claim 1, wherein the filter-reweight-retrain robust algorithm comprises:
training the estimator based on an objective function using a first dataset, the first dataset comprising data points that pass a particular test;
applying the estimator to a second dataset to obtain residual errors associated with data points of the second dataset, the data points of the second dataset comprising data points that fail the particular test with or without the first dataset;
obtaining a third dataset by removing data points having corresponding residual errors greater than a specific threshold from the second dataset; and
retraining the estimator based on the objective function using the third dataset or a combination of the first dataset and the third dataset.

3. The method of claim 2, further comprising performing the filter-reweight-retrain robust algorithm to obtain a new estimator in every predetermined time interval.

4. The method of claim 3, wherein the predetermined time interval comprises one second or less.

5. The method of claim 2, wherein the specific threshold depends on an average of the residual errors associated with the data points of the second dataset.

6. The method of claim 2, further comprising assigning a respective weight to each data point of the first dataset and the third dataset prior to retraining the estimator based on the objective function using the first dataset and the third dataset, the respective weight of each data point of the first dataset and the third dataset being dependent on a residual error associated with the respective data point obtained when the estimator is applied prior to the retraining.

7. The method of claim 1, wherein the information of the estimated vTEC value comprises a double difference value obtained based on the estimated vTEC value and relationships between locations of the plurality of ground stations and the location of the computing device.

8. The method of claim 1, wherein the system comprises a cloud computing system connected to the plurality of ground stations, or a ground station of the plurality of ground stations.

9. One or more computer readable media storing executable instructions that, when executed by one or more processors, cause the one or more processors to perform acts comprising:
training an estimator based on an objective function using a first dataset, the first dataset comprising data points that pass a particular test;
applying the estimator to a second dataset to obtain residual errors associated with data points of the second dataset, the data points of the second dataset comprising data points that fail the particular test with or without the first dataset;
obtaining a third dataset by removing data points having corresponding residual errors greater than a specific threshold from the second dataset; and
retraining the estimator based on the objective function using the third dataset or a combination of the first dataset and the third dataset, wherein the estimator is applied to estimate a vertical Total Electron Content (vTEC) value associated with a location coordinate in a Global Positioning System (GPS).

10. The one or more computer readable media of claim 9, wherein the objective function comprises a convex loss function.

11. The one or more computer readable media of claim 9, wherein the particular test comprises at least one of a closed loop test or an n-sigma test.

12. The one or more computer readable media of claim 9, the acts further comprising determining a double difference value from the vTEC value, the double difference value being used to correct an estimated value of the location coordinate obtained using the GPS.

13. The one or more computer readable media of claim 9, wherein retraining the estimator based on the objective function using the first dataset and the third dataset comprises determining an estimator that minimizes the objective function using the third dataset or the combination of the first dataset and the third dataset.

14. The one or more computer readable media of claim 9, wherein the specific threshold depends on an average of the residual errors associated with the data points of the second dataset.

15. The one or more computer readable media of claim 9, the acts further comprising assigning a respective weight to each data point of the first dataset and the third dataset prior to retraining the estimator based on the objective function using the first dataset and the third dataset, the respective weight of each data point of the first dataset and the third dataset being dependent on a residual error associated with the respective data point obtained when the estimator is applied prior to the retraining.

16. The one or more computer readable media of claim 9, the acts further comprising:
obtaining a new first dataset and a new second dataset; and
repeating the training, the applying, the obtaining, and the retraining using at least the new first dataset and the new second dataset.

17. The one or more computer readable media of claim 9, wherein at least some of data points of the first dataset and the data points of the second dataset are associated with location coordinates that are different from the location coordinate associated with the vTEC value.

18. A computing device comprising:
a Global Positioning System (GPS) receiver configured to receive a GPS signal;
one or more processors;
memory storing executable instructions that, when executed by the one or more processors, cause the one or more processors to perform acts comprising:
sending a request to one or more ground stations for receiving a double difference value estimated by an estimator that is trained using a filter-reweight-retrain robust algorithm, the double difference value being caused by an ionospheric delay;
receiving the double difference value from at least one ground station of the one or more ground stations; and
correcting at least an error associated with the ionospheric delay in the GPS signal received by the GPS receiver to obtain a corrected GPS signal; and
determining the current location of the computing device based on the corrected GPS signal.

19. The computing device of claim 18, wherein the sending, the receiving, the correcting and the determining are performed in substantially real time, or in every second or less.

20. The computing device of claim 18, wherein the filter-reweight-retrain robust algorithm comprises:
training the estimator based on an objective function using a first dataset, the first dataset comprising data points that pass a particular test;
applying the estimator to a second dataset to obtain residual errors associated with data points of the second dataset, the data points of the second dataset comprising data points that fail the particular test with or without the first dataset;
obtaining a third dataset by removing data points having corresponding residual errors greater than a specific threshold from the second dataset; and
retraining the estimator based on the objective function using the third dataset or a combination of the first dataset and the third dataset.
